(19) United States
(12) Patent Application Publication
(10) Pub. No.: US 2017/0221280 A1
(43) Pub. Date: Aug. 3, 2017

(54) SYSTEM AND METHOD FOR WORK VEHICLE SERVICE VERIFICATION

(71) Applicant: Deere & Company, Moline, IL (US)

(72) Inventors: Keith N. Chaston, Dubuque, IA (US); Eric S. Crawford, Champaign, IL (US); Joshua D. Hoffman, Davenport, IA (US); Mark J. Cherney, Potosi, WI (US); Niels Dybro, Sherrard, IL (US)

(21) Appl. No.: 15/009,173

(22) Filed: Jan. 28, 2016

(51) Int. Cl. G07C 5/08

(52) U.S. Cl. CPC G07C 5/08

(57) ABSTRACT

A service verification system and method are disclosed for a work vehicle having a component that requires maintenance checks. The service verification system includes a zone associated with the component, and the zone includes a source that actively transmits a zone identifier over the zone. The service verification system also includes a controller that receives and processes the zone identifier when the controller is in the zone, and based on the received zone identifier, the controller outputs at least one maintenance check to be completed for the component.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to work vehicles and to a verification of a maintenance service or maintenance check of a component of a work vehicle.

### BACKGROUND OF THE DISCLOSURE

In the construction industry, various work vehicles are operated to perform various tasks at a work site. For example, an articulated dump truck may be utilized to haul loads of material over rough terrain. Generally, one or more maintenance checks are desired to be performed prior to the operation of the work vehicle each day. These maintenance checks ensure that the work vehicle will be operating properly throughout the work day.

In certain examples, the maintenance checks and/or service are performed without a method to ensure that the component subject to the maintenance check is actually inspected and/or serviced prior to the operation of the work vehicle. Thus, this may enable the work vehicle to be operated without the routine maintenance being performed, which may increase warranty costs and/or reduce a life of one or more components of the work vehicle.

### SUMMARY OF THE DISCLOSURE

The disclosure provides a system and method for verifying a maintenance service of a work vehicle.

In one aspect the disclosure provides a service verification system for a work vehicle having a component that requires maintenance checks. The service verification system includes a zone associated with the component, and the zone includes a source that actively transmits a zone identifier over the zone. The service verification system also includes a controller that receives and processes the zone identifier when the controller is in the zone, and based on the received zone identifier, the controller outputs at least one maintenance check to be completed for the component.

In another aspect the disclosure provides a service verification method for a work vehicle having a component that requires maintenance checks. The method comprises actively transmitting a zone identifier over a zone associated with the component; and receiving, by a controller, the zone identifier when the controller is in the zone. The method comprises processing, by the controller, the received zone identifier; and outputting, by the controller, at least one maintenance check to be completed for the at least one component based on the processing.

In yet another aspect the disclosure provides a service verification system for a work vehicle having a plurality of components that each require maintenance checks. The service verification system includes a plurality of zones each associated with a respective one of the plurality of components, and each of the plurality of zones include a source that actively transmits a zone identifier over the respective one of the plurality of zones. The service verification system includes a controller that receives and processes the zone identifier when the controller is in the respective one of the plurality of zones, and based on the received zone identifier, the controller outputs at least one maintenance check to be completed for the component associated with the respective one of the plurality of zones.

The details of one or more embodiments are set forth in the accompanying drawings and the description below. Other features and advantages will become apparent from the description, the drawings, and the claims.

### BRIEF DESCRIPTION OF THE DRAWINGS

FIG. 1 is a perspective view of an example work vehicle in the form of an articulated dump truck in which the disclosed service verification system and method may be used;

FIG. 2 is a schematic illustration of an example service verification system for use with the work vehicle;

FIG. 3 is a schematic illustration of an example zone for service verification of the work vehicle;

FIG. 4 is a schematic illustration of an example zone for service verification of the work vehicle;

FIG. 5 is a schematic illustration of an example zone for service verification of the work vehicle;

FIG. 6 is a schematic illustration of an example zone for service verification of the work vehicle;

FIG. 7 is a dataflow diagram illustrating an example service verification system for the work vehicle in accordance with various embodiments; and

FIG. 8 is a flowchart illustrating an example control method of the disclosed service verification system of FIG. 1 in accordance with various embodiments.

Like reference symbols in the various drawings indicate like elements.

### DETAILED DESCRIPTION

The following describes one or more example embodiments of the disclosed system and method, as shown in the accompanying figures of the drawings described briefly above. Various modifications to the example embodiments may be contemplated by one of skill in the art.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of work vehicles, and that the articulated dump truck described herein is merely one exemplary embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The following describes one or more example implementations of the disclosed system for service verification for a work vehicle, as shown in the accompanying figures of the drawings described briefly above. Generally, the disclosed systems (and work vehicles in which they are implemented) provide for improved service verification as compared to conventional systems by requiring a unique zone identifier to be received by a controller of a portable electronic device, including, but not limited to, a tablet computing device, mobile or smart cellular phone, personal digital assistant, a laptop computing device, etc., prior to displaying a user interface that enables input to denote a completion of the maintenance check. By requiring a unique identifier prior to enabling a completion of a maintenance check, it is more likely that the maintenance check and/or service is performed by the operator of the work vehicle. Moreover, data regarding the verified completed maintenance checks and/or service of the work vehicle may be transmitted by the controller of the portable electronic device to a remote or telematics system. This may enable an owner of the work vehicle to evaluate whether maintenance checks and/or service are being completed as appropriate.

Discussion herein may sometimes focus on the example application of a service verification system for an articulated dump truck. In other applications, other configurations are also possible. For example, work vehicles in some embodiments may be configured as haulers or loaders, such as tractor loaders, crawler loaders or similar machines. Further, work vehicles may be configured as machines other than construction vehicles, including machines from the agriculture, forestry and mining industries, such as tractors, combines, harvesters, feller bunchers, and so on. Thus, the configuration of the service verification system for use in an articulated dump truck is merely an example.

Generally, the disclosed service verification system receives a zone identification that uniquely identifies a zone of the work vehicle and uniquely identifies the work vehicle when the portable electronic device is within the zone. In one example, the zone identification comprises a zone identification signal actively transmitted by a zone identification beacon associated with or coupled to a portion of the work vehicle, which is received and processed by the controller of the portable electronic device. Based on the receipt of the zone identification signal, the service verification system queries a local data store (i.e. a data store onboard the portable electronic device) to determine the zone, and queries a local data store to determine the type of work vehicle. It should be noted that the controller of the portable electronic device may also query a remote data store (i.e. a data store external to the portable electronic device) over a suitable wireless communication protocol to similarly determine the zone and the type of work vehicle based on the zone identification signal.

Based on the determined zone and type of work vehicle, the controller of the portable electronic device queries a local data store and retrieves a component that requires routine maintenance within the identified zone for the identified work vehicle. Based on the retrieved component, the controller queries a local data store and retrieves a maintenance check associated with that retrieved component. The maintenance check may include instructions for performing the maintenance task itself, and may include images that illustrate how to perform the maintenance check.

Based on the retrieved maintenance check, the controller outputs an enable maintenance check user interface for display on a display associated with the portable electronic device, which provides the maintenance check to be performed and enables the operator to input, via an input device associated with the portable electronic device, that the maintenance check has been completed. Based on receipt of a verification that the maintenance check has been completed, the controller determines if a subsequent component is within the identified zone for the identified work vehicle that requires a routine maintenance check, and if so, outputs a subsequent enable maintenance check user interface for display on the display. Once the maintenance checks are verified as complete, the controller outputs or transmits a service report or service report data to the remote or telematics system.

Alternatively, if no zone identification signal is received, the controller of the portable electronic device outputs a disable maintenance check user interface for display on the display, which does not enable input from the operator. Thus, the service verification system and method of the present disclosure ensures that maintenance checks are properly completed for a work vehicle.

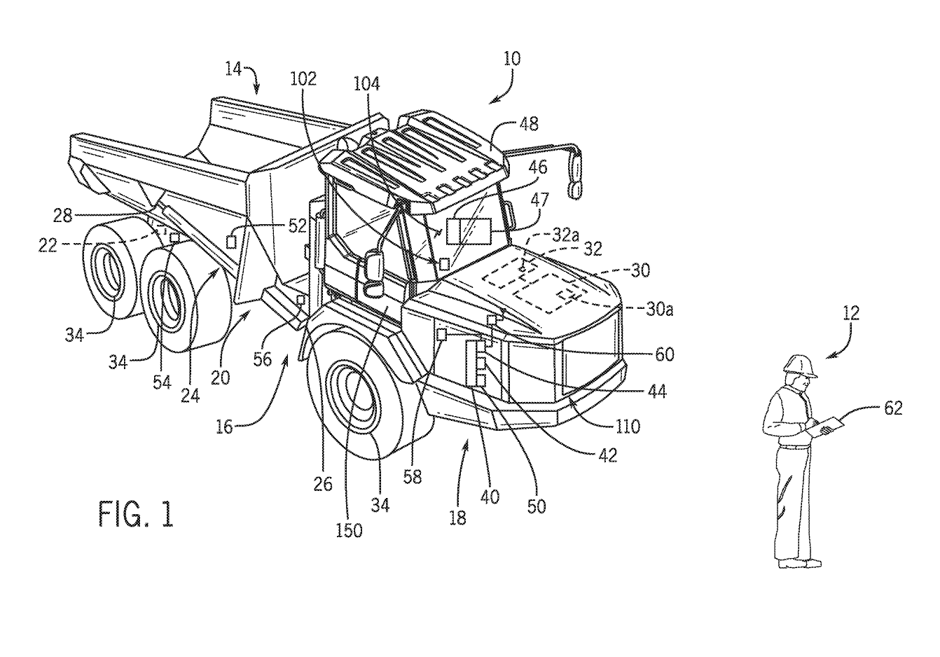

As noted above, the disclosed service verification system and method may be utilized with regard to various work vehicles, including articulated dump trucks, loaders, graders, tractors, combines, etc. Referring to FIG. 1, in some embodiments, the disclosed service verification system may be used with a work vehicle 10, such as an articulated dump truck (ADT), to ensure that an operator 12 of the work vehicle 10 has completed routine or periodic (i.e. daily, weekly, monthly, etc.) maintenance checks for various components of the work vehicle 10. In this example, the work vehicle 10 includes a work tool, such as a load bin 14, mounted to a vehicle frame 16. It will be understood that the configuration of the work vehicle 10 having a work tool as the load bin 14 is presented as an example only.

In the embodiment depicted, the vehicle frame 16 includes a first, front frame portion 18 and a second, rear frame portion 20, which are coupled together via an articulation joint (not shown) to enable pivotal movement between the front frame portion 18 and the rear frame portion 20. The load bin 14 is mounted to the rear frame portion 20 via coupling pins 22 that define a pivot point for the load bin 14. The load bin 14 defines a receptacle to receive a payload.

One or more hydraulic cylinders 24 are mounted to the rear frame portion 20 and to the load bin 14, such that the hydraulic cylinders 24 may be driven or actuated in order to pivot the load bin 14 about the coupling pins 22. Generally, the work vehicle 10 includes two hydraulic cylinders 24, one on a left side of the load bin 14 and one on a right side of the load bin 14 in a forward driving direction of the work vehicle 10. It should be noted, however, that the work vehicle 10 may have any number of hydraulic cylinders, such as one, three, etc. Each of the hydraulic cylinders 24 includes an end mounted to the rear frame portion 20 at a pin 26 and an end mounted to the load bin 14 at a pin 28. Upon activation of the hydraulic cylinders 24, the load bin 14 may be moved from a lowered, loaded position L (FIG. 1) to a raised, unloaded position R (not shown) to dump a payload contained within the load bin 14.

Thus, in the embodiment depicted, the load bin 14 is pivotable vertically relative to a horizontal axis by the one or more hydraulic cylinders 24. In other configurations, other movements of a load bin may be possible. Further, in some embodiments, a different number or configuration of hydraulic cylinders or other actuators may be used. Thus, it will be understood that the configuration of the load bin 14 is presented as an example only. In this regard, a load bin (e.g., the load bin 14) may be generally viewed as a receptacle that is pivotally attached to a vehicle frame. Similarly, a coupling pin (e.g., the coupling pins 22) may be generally viewed as a pin or similar feature effecting pivotal attachment of a load bin to a vehicle frame. In this light, a tilt actuator (e.g., the hydraulic cylinders 24) may be generally viewed as an actuator for pivoting a receptacle with respect to a vehicle frame.

The work vehicle 10 includes a source of propulsion, such as an engine 30. The engine 30 supplies power to a transmission 32. In one example, the engine 30 is an internal combustion engine, such as a diesel engine, that is controlled by an engine control module 30a. It should be noted that the use of an internal combustion engine is merely an example, as the propulsion device can be a fuel cell, an electric motor, a hybrid-gas electric motor, etc.

The transmission 32 transfers the power from the engine 30 to a suitable driveline coupled to one or more driven wheels 34 (and tires) of the work vehicle 10 to enable the work vehicle 10 to move. As is known to one skilled in the art, the transmission 32 can include a suitable gear transmission, which can be operated in a variety of ranges containing one or more gears, including, but not limited to a park range, a neutral range, a reverse range, a drive range, a low range, etc. In one example, the transmission 32 is controlled by a transmission control module 32a.

The work vehicle 10 also includes one or more pumps 40, which may be driven by the engine 30 of the work vehicle 10. Flow from the pumps 40 may be routed through various control valves 42 and various conduits (e.g., flexible hoses) in order to drive the hydraulic cylinders 24. Flow from the pumps 40 may also power various other components of the work vehicle 10. The flow from the pumps 40 may be controlled in various ways (e.g., through control of the various control valves 42), in order to cause movement of the hydraulic cylinders 24, and thus, movement of the work tool or the load bin 14 relative to the vehicle frame 16. In this way, for example, a movement of the load bin 14 between the lowered, loaded position L and the raised, unloaded position R may be implemented by various control signals to the pumps 40, control valves 42, and so on.

Generally, the controller 44 (or multiple controllers) may be provided, for control of various aspects of the operation of the work vehicle 10, in general. The controller 44 (or others) may be configured as a computing device with associated processor devices and memory architectures, as a hard-wired computing circuit (or circuits), as a programmable circuit, as a hydraulic, electrical or electro-hydraulic controller, or otherwise. As such, the controller 44 may be configured to execute various computational and control functionality with respect to the work vehicle 10 (or other machinery). In some embodiments, the controller 44 may be configured to receive input signals in various formats (e.g., as hydraulic signals, voltage signals, current signals, and so on), and to output command signals in various formats (e.g., as hydraulic signals, voltage signals, current signals, mechanical movements, and so on). In some embodiments, the controller 44 (or a portion thereof) may be configured as an assembly of hydraulic components (e.g., valves, flow lines, pistons and cylinders, and so on), such that control of various devices (e.g., pumps or motors) may be effected with, and based upon, hydraulic, mechanical, or other signals and movements.

The controller 44 may be in electronic, hydraulic, mechanical, or other communication with various other systems or devices of the work vehicle 10 (or other machinery). For example, the controller 44 may be in electronic or hydraulic communication with various actuators, sensors, and other devices within (or outside of) the work vehicle 10, including various devices associated with the pumps 40, control valves 42, and so on. The controller 44 may communicate with other systems or devices (including other controllers) in various known ways, including via a CAN bus (not shown) of the work vehicle 10, via wireless or hydraulic communication means, or otherwise. An example location for the controller 44 is depicted in FIG. 1. It will be understood, however, that other locations are possible including other locations on the work vehicle 10, or various remote locations.

In some embodiments, the controller 44 may be configured to receive input commands and to interface with an operator via a human-machine interface 46, which may be disposed inside a cab 48 of the work vehicle 10 for easy access by the operator. The human-machine interface 46 may be configured in a variety of ways. In some embodiments, the human-machine interface 46 may include an input device 45 comprising one or more joysticks, various switches or levers, one or more buttons, a touchscreen interface that may be overlaid on a display 47, a keyboard, a speaker, a microphone associated with a speech recognition system, or various other human-machine interface devices. The human-machine interface 46 also includes the display 47, which can be implemented as a flat panel display or other display type that is integrated with an instrument panel or console of the work vehicle 10. Those skilled in the art may realize other techniques to implement the display 47 in the work vehicle 10.

Various sensors may also be provided to observe various conditions associated with the work vehicle 10. In some embodiments, various sensors 50 (e.g., pressure, flow or other sensors) may be disposed near the pumps 40 and control valves 42, or elsewhere on the work vehicle 10. For example, sensors 50 may include one or more pressure sensors that observe a pressure within the hydraulic circuit, such as a pressure associated with at least one of the one or more hydraulic cylinders 24. The sensors 50 may also observe a pressure associated with the pumps 40. In some embodiments, various sensors may be disposed near the load bin 14. For example, sensors 52 (e.g. load sensors) may be disposed on or coupled near the load bin 14 in order to measure parameters including the load in the load bin 14 and so on.

Various sensors 54 may also be disposed on or near the rear frame portion 20 in order to measure parameters, such as an incline or slope of the rear frame portion 20, and so on. In some embodiments, the sensors 54 may include an inclinometer coupled to or near the rear frame portion 20, etc. In certain embodiments, the sensors 54 may be microelectromechanical sensors (MEMS) that observe a force of gravity and an acceleration associated with the work vehicle 10. In addition, various sensors 56 are disposed near the rear frame portion 20 in order to observe an orientation of the load bin 14 relative to the rear frame portion 20. In some embodiments, the sensors 56 include angular position sensors coupled between the rear frame portion 20 and the load bin 14 in order to detect the angular orientation of the load bin 14 relative to the rear frame portion 20.

The various components noted above (or others) may be utilized to control movement of the load bin 14 via control of the movement of the one or more hydraulic cylinders 24. Each of the sensors 50, 52, 54 and 56 may be in communication with the controller 44 via a suitable communication architecture, such as the CAN bus associated with the work vehicle 10.

In this example, a portable electronic device 62 associated with the operator 12 provides service verification by confirming that the routine maintenance checks have been performed by the operator 12. By confirming that the routine maintenance checks have been performed, warranty costs may be decreased, and repairs to one or more systems of the work vehicle 10 may be decreased. The portable electronic device 62 is any suitable nomadic electronic device discrete or separate from the work vehicle 10, including, but not limited to, a hand-held portable electronic device, such as a tablet computing device, mobile or smart cellular phone, personal digital assistant, a laptop computing device, etc.

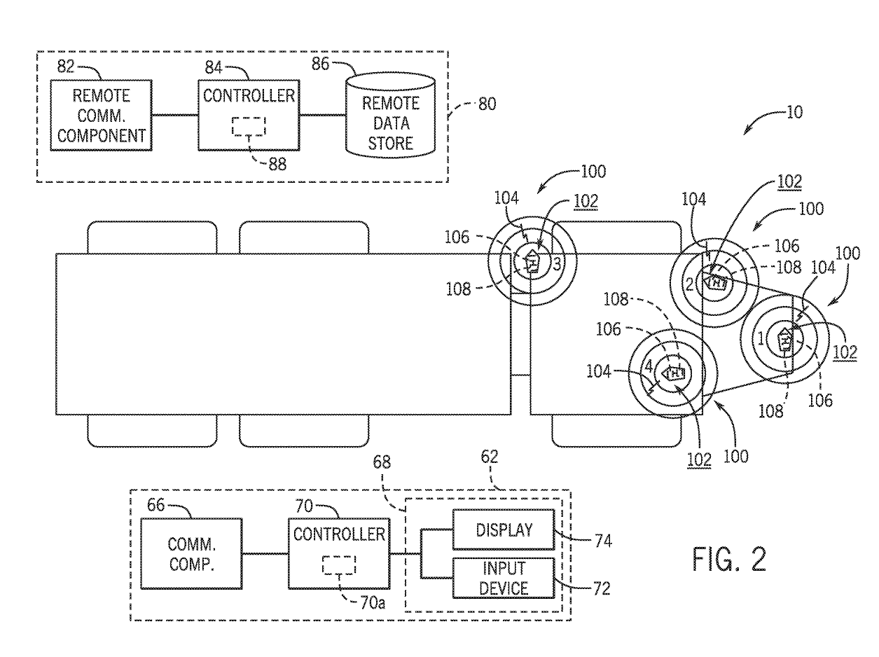

With reference to FIG. 2, the portable electronic device 62 includes a device communication component 66, a device user interface 68 and a device controller 70. The device communication component 66 comprises any suitable system for receiving data from and transmitting data to a remote system 80. For example, the device communication component 66 may include a radio configured to receive data transmitted by modulating a radio frequency (RF) signal from a remote station (not shown) as is well known to those skilled in the art. For example, the remote station (not shown) may be part of a cellular telephone network and the data may be transmitted according to the long-term evolution (LTE) standard. The device communication component 66 also transmits data to the remote station (not shown) to achieve bi-directional communications. However, other techniques for transmitting and receiving data may alternately be utilized. For example, the device communication component 66 may achieve bi-directional communications with the remote station 80 over Bluetooth® or by utilizing a Wi-Fi standard, i.e., one or more of the 802.11 standards as defined by the Institute of Electrical and Electronics Engineers (“IEEE”), as is well known to those skilled in the art. Thus, the device communication component 66 comprises a Bluetooth® transceiver, a radio transceiver, a cellular transceiver, an LTE transceiver and/or a Wi-Fi transceiver.

The device communication component 66 may also be configured to encode data or generate encoded data. The encoded data generated by the device communication component 66 may be encrypted. A security key may be utilized to decrypt and decode the encoded data, as is appreciated by those skilled in the art. The security key may be a “password” or other arrangement of data that permits the encoded data to be decrypted.

The device user interface 68 allows the user of the portable electronic device 62 to interface with the portable electronic device 62 (e.g. to input commands and data). In one example, the device user interface 68 includes an input device 72 and a display 74. The input device 72 is any suitable device capable of receiving user input, including, but not limited to, a keyboard, a microphone, a touchscreen layer associated with the display 74, or other suitable device to receive data and/or commands from the user. Of course, multiple input devices 72 can also be utilized. The display 74 comprises any suitable technology for displaying information, including, but not limited to, a liquid crystal display (LCD), organic light emitting diode (OLED), plasma, or a cathode ray tube (CRT).

The device controller 70 is in communication with the device communication component 66 and the device user interface 68 over a suitable interconnection architecture or arrangement that facilitates transfer of data, commands, power, etc. The device controller 70 may be configured as a computing device with associated processor devices and memory architectures, as a hard-wired computing circuit (or circuits), as a programmable circuit, or otherwise. The device controller 70 includes a device control module 70a embedded within the device controller 70, which receives input from the device user interface 68 and sets data, such as verification data, for transmission by the device communication component 66 to the remote system 80 based on the input from the device user interface 68.

In certain embodiments, the device communication component 66 is in communication with the remote system 80. In one example, the remote system 80 comprises the JDLink™ system commercially available from Deere & Company of Moline, Ill.; however, the remote system 80 may comprise any suitable telematics system. The remote system 80 includes a remote communication component 82, a remote controller 84 and one or more remote data stores 86. The remote communication component 82 comprises any suitable system for receiving data from and transmitting data to the device communication component 66. For example, the remote communication component 82 may include a radio configured to receive data transmitted by modulating a radio frequency (RF) signal from a remote station (not shown) as is well known to those skilled in the art. For example, the remote station (not shown) may be part of a cellular telephone network and the data may be transmitted according to the long-term evolution (LTE) standard. The remote communication component 82 also transmits data to the remote station (not shown) to achieve bi-directional communications. However, other techniques for transmitting and receiving data may alternately be utilized. For example, the remote communication component 82 may achieve bi-directional communications with the device communication component 66 over Bluetooth®, satellite, or by utilizing a Wi-Fi standard, i.e., one or more of the 802.11 standards as defined by the Institute of Electrical and Electronics Engineers (“IEEE”), as is known to those skilled in the art. Thus, the remote communication component 82 comprises a Bluetooth® transceiver, a radio transceiver, a cellular transceiver, a satellite transceiver, an LTE transceiver and/or a Wi-Fi transceiver.

The remote communication component 82 may also be configured to encode data or generate encoded data. The encoded data generated by the remote communication component 82 may be encrypted. A security key may be utilized to decrypt and decode the encoded data, as is appreciated by those skilled in the art. The security key may be a “password” or other arrangement of data that permits the encoded data to be decrypted.

The remote controller 84 is in communication with the remote communication component 82 and the one or more remote data stores 86 over a suitable interconnection architecture or arrangement that facilitates transfer of data, commands, power, etc. The remote controller 84 may also be in communication with one or more remote users via a portal, such as a web-based portal. The remote controller 84 may be configured as a computing device with associated processor devices and memory architectures, as a hard-wired computing circuit (or circuits), as a programmable circuit, or otherwise. The remote controller 84 includes a remote control module 88 embedded within the remote controller 84, which receives data communicated from the portable electronic device 62 and sets data, such as service report data for a particular work vehicle 10 for one or more of the remote data stores 86. In one example, at least one of the one or more remote data stores 86 stores data, such as the service report data of the work vehicle 10. The service report data of the work vehicle 10 may be stored in any desired format, and may comprise one or more tables. The tables may be indexed by machine name, etc. to enable retrieval of the service report data upon a request received from a remote user in communication with the remote controller 84 via the web-based portal.

With continued reference to FIG. 2, one or more zones 100 of the work vehicle 10 are subject to routine maintenance checks. In one example, the work vehicle 10 includes at least four zones 100 (each numbered 1-4 in FIG. 2); however, the work vehicle 10 may include any number of zones 100. Each of the zones 100 includes one or more components or systems of the work vehicle 10 that require routine maintenance checks and/or service. In this example, each of the zones 100 are defined by a zone identification beacon 102 coupled to the work vehicle 10. In one example, the zone identification beacon 102 comprises an iBeacon-compatible hardware transmitter; however, the zone identification beacon 102 may comprise any suitable active transmitter. In this example, the zone identification beacon 102 comprises a Bluetooth® transmitter that communicates with the portable electronic device 62 over Bluetooth®, such as Bluetooth® low energy (LE or BLE) or Bluetooth® Smart. It should be noted that the use of Bluetooth® is merely exemplary, as any suitable communication protocol may be employed, such as a Wi-Fi standard. The zone identification beacon 102 actively transmits a unique zone identification signal 104 over the communication protocol, in this example Bluetooth®, which is received by the device communication component 66. In the context of this disclosure “actively transmits” is used to denote the substantially continuous transmission of the zone identification signal 104 by a beacon communication component 106. Stated another way, the zone identification beacon 102 substantially continuously generates the zone identification signal 104 and substantially continuously broadcasts or transmits the zone identification signal 104 with the beacon communication component 106 over a life of the zone identification beacon 102 (1-way transmitter). Thus, as the zone identification signal 104 is substantially continuously transmitted by the zone identification beacon 102, the device communication component 66 receives the zone identification signal 104 when the portable electronic device 62 is in proximity to the zone identification beacon 102.

In the example of the zone identification signal 104 broadcast via Bluetooth®, the device communication component 66 receives the zone identification signal 104 within a pre-defined or pre-set range of the beacon communication component 106, as indicated by the concentric circles in FIG. 2 surrounding each of the zone identification beacons 102. In one example, the pre-defined or pre-set range is about 10 feet; however, the pre-defined or pre-set range may be about 15 feet, depending upon the work vehicle 10. Moreover, as will be discussed herein, the range of the beacon communication component 106 may be adjusted to account for shielding of the zone identification signal 104 by the structure of the work vehicle 10. It should be noted that the location of each of the zone identification beacons 102 around the work vehicle 10 is merely exemplary, as the zone identification beacon 102 may be coupled to the work vehicle 10 at any desired location.

With reference to FIG. 2, the zone identification beacon 102 also generally includes a beacon controller 108. The beacon controller 108 may be configured as a computing device with associated processor devices and memory architectures, as a hard-wired computing circuit (or circuits), as a programmable circuit, or otherwise. The beacon controller 108 is in communication with the beacon communication component 106, and includes a control module 108a embedded within the beacon controller 108. The control module 108a generates the unique zone identification signal 104, and is programmed to command the beacon communication component 106 to continuously broadcast the zone identification signal 104. In the example of an iBeacon, the control module 108a may be factory set with a pre-defined universally unique identifier, which is received by the device communication component 66 of the portable electronic device 62 and from which the device controller 70 of the portable electronic device 62 determines the particular work vehicle (work vehicle 10) and the particular zone 100 associated with the zone identification beacon 102. Thus, the universally unique identifier generally includes both an identifier of the work vehicle 10 (e.g. ADT) and of the particular zone (e.g. 1, 2, 3, etc.) of the work vehicle 10.

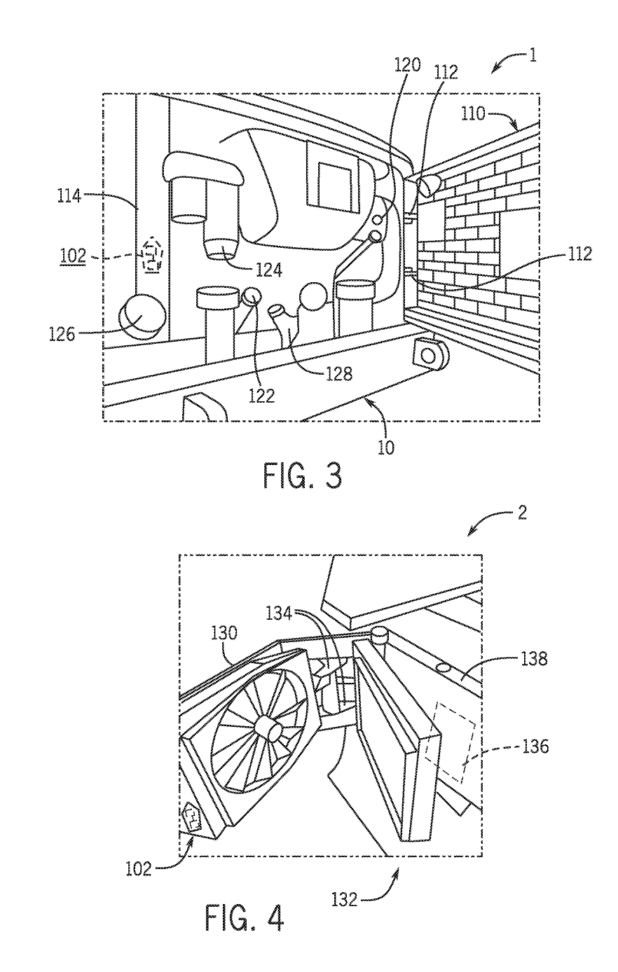

With reference to FIG. 3, an exemplary zone 1 is shown in greater detail. In this example, zone 1 is defined near the engine 30, behind a front grille 110 of the work vehicle 10. Generally, the front grille 110 encloses the engine 30, and is pivotable between an opened position and a closed position via one or more hinges 112. In this example, the hinges 112 are coupled to the front frame portion 18 such that the front grille 110 pivots along an axis substantially perpendicular to the horizon. It should be noted, however, that the front grille 110 may be positionable in any desired manner relative to the front frame portion 18, and moreover, zone 1 may be defined underneath a hood or other enclosure associated with the engine 30.

In this example, the zone identification beacon 102 is positioned behind a beam 114 that extends within an engine compartment defined by the front frame portion 18. By positioning the zone identification beacon 102 behind the beam 114 and behind the front grille 110, the signal of the zone identification beacon 102 is partially obstructed by the beam 114 and/or front grille 110, which requires the operator 12 to open the front grille 110 to perform the maintenance checks associated with zone 1. In this regard, as the beam 114 and the front grille 110 are generally formed of metal or metal alloy, which interfere with or block the zone identification signal 104, in order for the maintenance checks to be completed for zone 1, the operator 12 has to open the front grille 110.

Zone 1 generally includes one or more components associated with the work vehicle 10 that require routine maintenance or maintenance checks to ensure proper operation of the work vehicle 10. For example, a master disconnect switch 120 is a component of the work vehicle 10 that requires a periodic maintenance check. In this example, the master disconnect switch 120 is located behind the front grille 110. A movement of the master disconnect switch 120 from an OFF position to an ON position is a periodic maintenance check associated with the work vehicle 10. Further, the engine 30 is a component of the work vehicle 10 in zone 1 that requires one or more periodic maintenance checks. For example, a level of the engine oil comprises a periodic maintenance check to ensure that the engine 30 has sufficient oil for proper operation. In one example, the engine oil level may be read from a dipstick 122 associated with the engine 30.

In addition, a fuel filter and water separator system 124 associated with the engine 30 is a component of the work vehicle 10 that requires a periodic maintenance check. In this example, the periodic maintenance check comprises checking the fuel filter for debris and checking a level of the water separator. If the fuel filter is dirty, the periodic maintenance check may require replacing the fuel filter prior to operation of the engine 30. Moreover, if the water separator level is above a threshold, the periodic maintenance check may require the draining of the water separator to ensure a proper fuel supply to the engine 30. A fuel tank (not shown) is also a component of the work vehicle 10 that requires a periodic maintenance check. In this example, the addition of fuel to the fuel tank via a fuel tank inlet 126 may comprise a periodic maintenance check.

Further, a windshield wiper fluid bottle 128 is a component of the work vehicle 10 that requires a periodic maintenance check. In one example, a periodic maintenance check comprises inspecting a level of washer fluid within the windshield wiper fluid bottle 128, and another periodic maintenance check may include adding washer fluid to the windshield wiper fluid bottle 128.

With reference to FIG. 4, an exemplary zone 2 is shown in greater detail. In this example, zone 2 is defined near the engine 30, behind a fan door 130 of the work vehicle 10. Generally, the fan door 130 encloses a cooling system 132 associated with the engine 30, and is pivotable between an opened position and a closed position via one or more hinges 134. In this example, the hinges 134 are coupled to the front frame portion 18 such that the fan door 130 pivots along an axis substantially perpendicular to the horizon. It should be noted, however, that the fan door 130 may be positionable in any desired manner relative to the front frame portion 18, and moreover, zone 2 may be defined behind a removable panel or other enclosure associated with the work vehicle 10.

In this example, the zone identification beacon 102 is coupled to the fan door 130. By positioning the zone identification beacon 102 behind the fan door 130, the signal of the zone identification beacon 102 is partially obstructed by the fan door 130, which requires the operator 12 to open the fan door 130 to perform the maintenance checks associated with zone 2. In this regard, as the fan door 130 is generally formed of metal or metal alloy, which interferes with or blocks the zone identification signal 104, in order for the maintenance checks to be completed for zone 2, the operator 12 has to open the fan door 130.

Zone 2 generally includes one or more components associated with the work vehicle 10 that require routine maintenance or maintenance checks to ensure proper operation of the work vehicle 10. For example, the cooling system 132 includes a coolant recovery bottle 136, which is a component of the work vehicle 10 that requires a periodic maintenance check. In one example, a periodic maintenance check comprises inspecting a level of fluid in the coolant recovery bottle 136, and may include adding additional coolant if the level is below a threshold.

A radiator 138 is also a component of the work vehicle 10 that requires a periodic maintenance check. In one example, a periodic maintenance check comprises inspecting the radiator 138 for debris, and another periodic maintenance check may include removing the debris from the radiator 138.

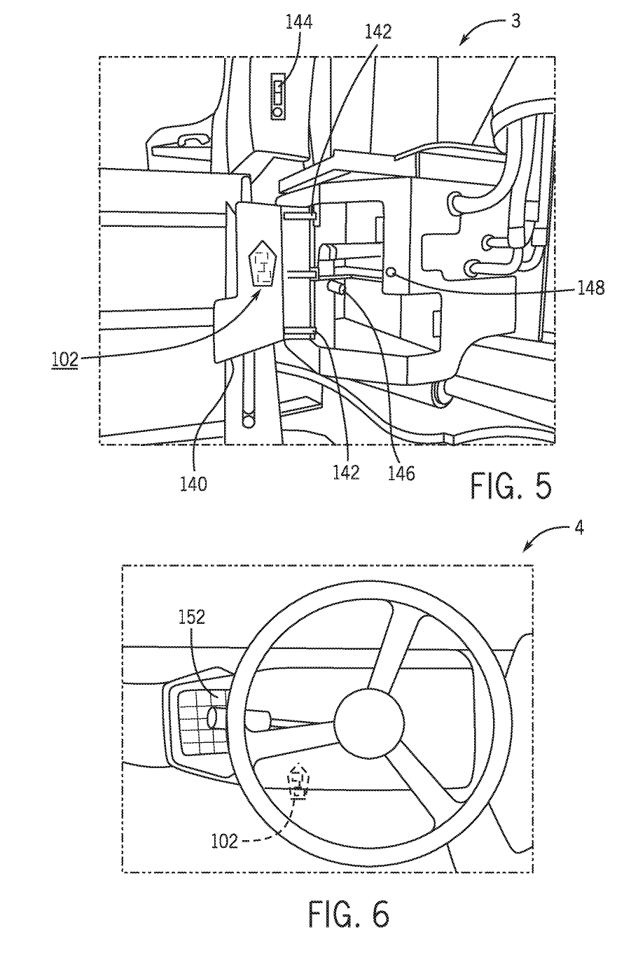

With reference to FIG. 5, an exemplary zone 3 is shown in greater detail. In this example, zone 3 is defined behind a transmission service door 140 of the work vehicle 10, which in one example, is located behind the cab 48 of the work vehicle 10. Generally, the transmission service door 140 provides access to a portion of the transmission 32, and is pivotable between an opened position and a closed position via one or more hinges 142. In this example, the hinges 142 are coupled to the front frame portion 18 such that the transmission service door 140 pivots along an axis substantially perpendicular to the horizon. It should be noted, however, that the transmission service door 140 may be positionable in any desired manner relative to the front frame portion 18, and moreover, zone 3 may be defined behind a removable panel or other enclosure associated with the work vehicle 10.

In this example, the zone identification beacon 102 is coupled to the transmission service door 140. By positioning the zone identification beacon 102 behind the transmission service door 140, the signal of the zone identification beacon 102 is partially obstructed by the transmission service door 140, which requires the operator 12 to open the transmission service door 140 to perform the maintenance checks associated with zone 3. In this regard, as the transmission service door 140 is generally formed of metal or metal alloy, which interferes with or blocks the zone identification signal 104, in order for the maintenance checks to be completed for zone 3, the operator 12 has to open the transmission service door 140.

Zone 3 generally includes one or more components associated with the work vehicle 10 that require routine maintenance or maintenance checks to ensure proper operation of the work vehicle 10. A hydraulic fluid level indicator 144 is a component of the work vehicle 10 that requires a periodic maintenance check. In one example, a periodic maintenance check comprises inspecting a hydraulic fluid level, which is read from the hydraulic fluid level indicator 144, and another periodic maintenance check may include adding hydraulic fluid.

A transmission oil level dipstick 146 is a component of the work vehicle 10 that requires a periodic maintenance check. In one example, a periodic maintenance check comprises inspecting a transmission oil level, which is read from the transmission oil level dipstick 146, and another periodic maintenance check may include adding oil to the transmission 32. A stairway service light 148 is a component of the work vehicle 10 that requires a periodic maintenance check. In one example, a periodic maintenance check comprises turning the stairway service light 148 on, if necessary.

With reference to FIG. 6, an exemplary zone 4 is shown in greater detail. In this example, zone 4 is defined within the cab 48, behind a door 150 of the work vehicle 10 (FIG. 1). In this example, the zone identification beacon 102 is positioned within the cab 48. By positioning the zone identification beacon 102 with the cab 48 so as to be enclosed by the cab 48, the signal of the zone identification beacon 102 is partially obstructed by the door 150, which requires the operator 12 to open the door 150 to perform the maintenance checks associated with zone 4. In this regard, as the door 150 is generally formed of metal or metal alloy, which interferes with or blocks the zone identification signal 104, in order for the maintenance checks to be completed for zone 4, the operator 12 has to open the door 150.

Zone 4 generally includes one or more components associated with the work vehicle 10 that require routine maintenance or maintenance checks to ensure proper operation of the work vehicle 10. For example, an instrument panel 152 is a component of the work vehicle 10 that requires a periodic maintenance check. In one example, a periodic maintenance check comprises inspecting one or more sensor readings displayed on the instrument panel 152. It should be noted that the instrument panel 152 may comprise a portion of the human-machine interface 46 of the work vehicle 10.

It should be noted that various other components of the work vehicle 10 may be subject to periodic maintenance checks, and thus, the above description of zones 1-4 is merely exemplary. For example, one or more fittings associated with one or more joints of the work vehicle 10 may be subject to weekly maintenance checks to ensure proper lubrication at the joints. Moreover, the zones 1-4 described above may include additional components, and thus, the description of the components in zones 1-4 is merely exemplary.

In various embodiments, the device controller 70 of the portable electronic device 62 outputs one or more service reports to the remote system 80 based on communications received from the zone identification beacon 102, input received from the input device 72, and further based on the service verification system and method of the present disclosure. The device controller 70 of the portable electronic device 62 outputs one or more user interfaces for display on the display 74 that are enabled to receive input that verifies one or more maintenance checks are completed based on communications received from the zone identification beacon 102, and further based on the service verification system and method of the present disclosure. The device controller 70 outputs one or more user interfaces for display on the display 74 that are disabled based on the service verification system and method of the present disclosure.

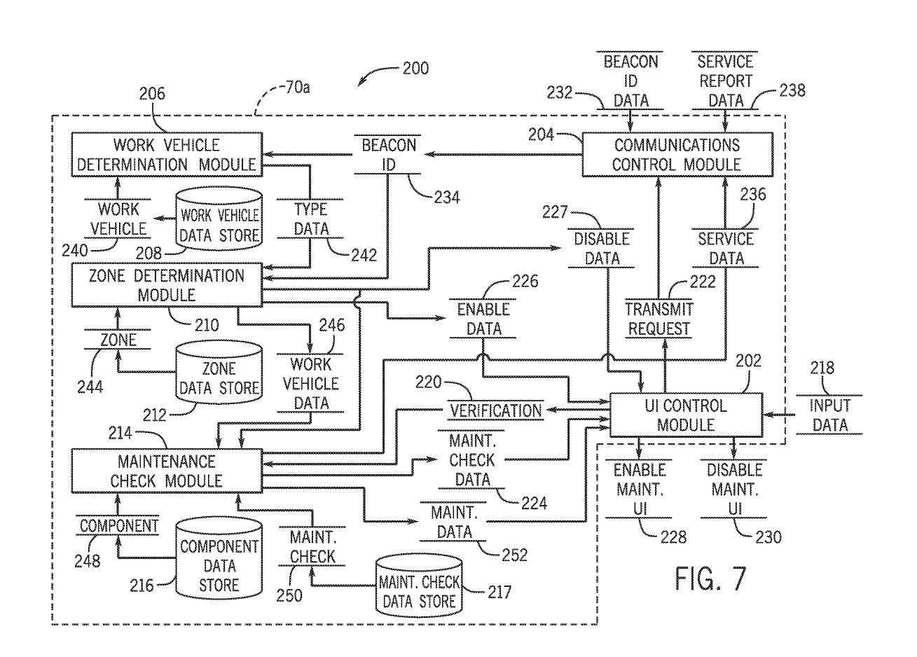

Referring now also to FIG. 7, and with continuing reference to FIGS. 1 and 2, a dataflow diagram illustrates various embodiments of a service verification system 200 for the work vehicle 10, which may be embedded within the device control module 70a of the device controller 70. Various embodiments of the service verification system 200 according to the present disclosure can include any number of sub-modules embedded within the device controller 70. As can be appreciated, the sub-modules shown in FIG. 7 can be combined and/or further partitioned to similarly verify the completion of one or more maintenance checks and to output service reports. Inputs to the service verification system 200 may be received from zone identification beacon 102 (FIG. 2), received from the input device 72 (FIG. 2), received from other control modules (not shown) associated with the work vehicle 10, and/or determined/modeled by other sub-modules (not shown) within the device controller 70. In various embodiments, the device control module 70a includes a user interface (UI) control module 202, an communications control module 204, a work vehicle determination module 206, a work vehicle data store 208, a zone determination module 210, a zone data store 212, a maintenance check module 214, a component data store 216 and a maintenance check data store 217. It will be understood that one or more of the modules associated with the service verification system 200 of the device controller 70 may be implemented as an application (i.e. an “app”), which may be downloaded by a user to the portable electronic device 62.

The UI control module 202 receives input data 218 from the input device 72. In certain embodiments, the input data 218 includes a verification that a maintenance check has been completed or a request to transmit a service report to the remote system 80. The UI control module 202 interprets the input data 218, and sets a verification 220 for the maintenance check module 214 or sets a transmit request 222 for the communications control module 204. The verification 220 comprises data that indicates the maintenance check has been performed, and the transmit request 222 comprises the request to transmit a service report to the remote system 80.

The UI control module 202 also receives as input maintenance check data 224 from the maintenance check module 214. The maintenance check data 224 comprises a maintenance check to be performed on a component of an identified zone of an identified work vehicle. The UI control module 202 also receives as input enable data 226 and disable data 227. The enable data 226 indicates that the portable electronic device 62 is within the identified zone of the identified work vehicle, and thus, a maintenance check is able to be completed. The disable data 227 indicates that the portable electronic device 62 is not within proximity to a zone or work vehicle, and thus, a maintenance check is not able to be completed. In certain examples, the disable data 227 may be factory set as a default value.

Based on the maintenance check data 224 and the enable data 226, the UI control module 202 outputs an enable maintenance check user interface 228 for display on the display 74. In one example, the enable maintenance check user interface 228 comprises instructions regarding a maintenance check for a component that requires routine maintenance, and may include an image of the component and/or instructions regarding the maintenance check to be performed on the component. The enable maintenance check user interface 228 also includes one or more completion selectors, such as buttons, input boxes etc., which are enabled so that the operator 12 is able to input the verification 220.

Based on the maintenance data 252 and the disable data 227, the UI control module 202 outputs a disable maintenance check user interface 230 for display on the display 74. In one example, the disable maintenance check user interface 230 comprises one or more instructions regarding a maintenance check for a component that requires routine maintenance, and may include an image of the component and/or instructions regarding the maintenance check to be performed on the component. The disable maintenance check user interface 230 also includes one or more completion selectors, such as buttons, input boxes etc., which are disabled so that the operator 12 cannot input the verification 220. Stated another way, the disable maintenance check user interface 230 enables the operator 12 to view the one or more components available within the maintenance check data store 217 that require routine maintenance, but is unable to verify that the maintenance has been performed.

The communications control module 204 receives as input beacon ID data 232. The beacon ID data 232 is received from the zone identification beacon 102. The beacon ID data 232 comprises the zone identification signal 104, which is actively transmitted by the zone identification beacon 102 and received by the device communication component 66. Based on the receipt of the beacon ID data 232, the communications control module 204 interprets the beacon ID data 232 and sets a beacon ID 234 for the work vehicle determination module 206 and for the zone determination module 210. The beacon ID 234 comprises the universally unique identifier transmitted by the zone identification beacon 102.

The communications control module 204 also receives as input the transmit request 222 and service data 236 from the maintenance check module 214. The service data 236 comprises data that indicates one or more maintenance checks have been verified as completed for one or more components of the work vehicle 10. Based on receipt of the transmit request 222, the communications control module 204 generates service report data 238 based on the service data 236 and transmits the service report data 238 to the remote system 80. The service report data 238 comprises all of the maintenance checks completed for the work vehicle 10, which is generated from the received service data 236. The service report data 238 may comprise a list of the components for which maintenance checks were verified, a list of zones with verified maintenance checks, etc.

The work vehicle data store 208 stores one or more tables (e.g., lookup tables) that indicate a work vehicle associated with a particular beacon ID. In other words, the work vehicle data store 208 stores one or more tables that provide a work vehicle 240 based on the beacon ID 234. In one example, the work vehicle 240 comprises a type of work vehicle (e.g. loader, grader, ADT, etc.). Thus, the work vehicle data store 208 may store one or more tables that provide the work vehicle 240 based on the universally unique identifier provided by the zone identification beacon 102. In various embodiments, the tables may comprise lists that are defined by one or more indexes. As an example, one or more tables can be indexed by various parameters such as, but not limited to, the universally unique identifier from the zone identification beacon 102, to provide the work vehicle 240.

In certain embodiments, the work vehicle determination module 206 receives as input the beacon ID 234. Based on the beacon ID 234, the work vehicle determination module 206 queries the work vehicle data store 208 to retrieve the work vehicle 240 that is associated with the beacon ID 234. Based on the retrieval of the work vehicle 240, the work vehicle determination module 206 sets type data 242 for the zone determination module 210. In this example, the type data 242 comprises the type of work vehicle that has been identified based on the beacon ID 234.

The zone data store 212 stores one or more tables (e.g., lookup tables) that indicate a zone associated with a particular beacon ID and a particular type of work vehicle. In other words, the zone data store 212 stores one or more tables that provide a zone 244 based on the beacon ID 234 and the type data 242. In one example, the zone 244 comprises a zone (e.g. 1, 2, 3, 4, etc.) for the particular work vehicle based on the universally unique identifier provided by the zone identification beacon 102. Thus, the zone data store 212 may store one or more tables that provide the zone 244 based on the universally unique identifier provided by the zone identification beacon 102 and the type data 242 that indicates the type of work vehicle 10. In this regard, as certain types of work vehicles may have different zones than another type of work vehicle, and as different zones of different types of work vehicles may include different components for maintenance checks, the zone data store 212 enables the identification of the particular zone for the particular type of work vehicle 10 to ensure that the one or more maintenance checks displayed on the display 74 via the enable maintenance check user interface 228 corresponds with the particular work vehicle 10. In various embodiments, the tables of the zone data store 212 may comprise lists that are defined by one or more indexes. As an example, one or more tables can be indexed by various parameters such as, but not limited to, the universally unique identifier from the zone identification beacon 102, the type of work vehicle 10 from the type data 242, to provide the zone 244.

In certain embodiments, the zone determination module 210 receives as input the beacon ID 234. Based on the receipt of the beacon ID 234, the zone determination module 210 sets the enable data 226 for the UI control module 202. If no beacon ID 234 is received, the zone determination module 210 sets the disable data 227 for the UI control module 202.

The zone determination module 210 also receives as input the beacon ID 234 and the type data 242. Based on the beacon ID 234 and the type data 242, the zone determination module 210 queries the zone data store 212 to retrieve the zone 244 that is associated with the beacon ID 234 and the type data 242. Based on the retrieval of the zone 244, the zone determination module 210 sets work vehicle data 246 for the maintenance check module 214. In this example, the work vehicle data 246 comprises the identified type of work vehicle and the identified zone for the type of work vehicle based on the beacon ID 234.

The component data store 216 stores one or more tables (e.g., lookup tables) that indicate a component that requires a routine maintenance check, which is associated with a particular zone and a particular type of work vehicle. In other words, the component data store 216 stores one or more tables that provide a component 248 based on the work vehicle data 246. In one example, the component 248 comprises a component that requires routine maintenance for the identified zone and type of the work vehicle. Thus, the component data store 216 may store one or more tables that provide the component 248 that requires a routine maintenance check based on the identified zone and identified the type of work vehicle 10. In various embodiments, the tables of the component data store 216 may comprise lists that are defined by one or more indexes. As an example, one or more tables can be indexed by various parameters such as, but not limited to, the zone, the type of work vehicle 10, to provide the component 248.

The maintenance check data store 217 stores one or more tables (e.g., lookup tables) that indicate a maintenance check for a particular component. In other words, the maintenance check data store 217 stores one or more tables that provide a maintenance check 250 based on the component 248 identified for the particular zone of the particular work vehicle. In one example, the maintenance check 250 comprises instructions for performing the routine maintenance check for the component 248, and may include images of how to perform the maintenance check on the component 248 and/or images of the component 248. Thus, the maintenance check data store 217 may store one or more tables that provide the routine maintenance check 250 based on the identified component. In various embodiments, the tables of the maintenance check data store 217 may comprise lists that are defined by one or more indexes. As an example, one or more tables can be indexed by various parameters such as, but not limited to, the component, the zone, the type of work vehicle 10, to provide the maintenance check 250.

The maintenance check module 214 receives as input the work vehicle data 246. Based on the work vehicle data 246, the maintenance check module 214 queries the component data store 216 to retrieve the component 248 that is associated with the work vehicle data 246. Based on the retrieval of the component 248, the maintenance check module 214 queries the maintenance check data store 217 to retrieve the maintenance check 250 associated with the component 248. The maintenance check module 214 sets the maintenance check data 224 for the UI control module 202. The maintenance check data 224 comprises the routine maintenance check associated with the identified component of the particular zone of the particular work vehicle.

The maintenance check module 214 also receives as input the verification 220 from the UI control module 202. Based on the verification 220, the maintenance check module 214 sets the service data 236, which indicates that the maintenance check for the particular component has been verified as completed. Based on the receipt of the verification 220, the maintenance check module 214 also determines whether additional components are associated with the zone of the particular work vehicle that require routine maintenance checks. Based on this determination, the maintenance check module 214 may also set maintenance check data 224 for subsequently identified components 248 and maintenance checks 250 within the identified zone and identified type of work vehicle 10.

The maintenance check module 214 receives as input the disable data 227. Based on the receipt of the disable data 227, the maintenance check module 214 queries the maintenance check data store 217 and retrieves one or more maintenance checks 250. The maintenance check module 214 sets maintenance data 252 for the UI control module 202, which includes the one or more maintenance checks 250 available within the maintenance check data store 217. Stated another way, the maintenance check module 214 sets the available maintenance checks 250 stored in the maintenance check data store 217 for the UI control module 202.

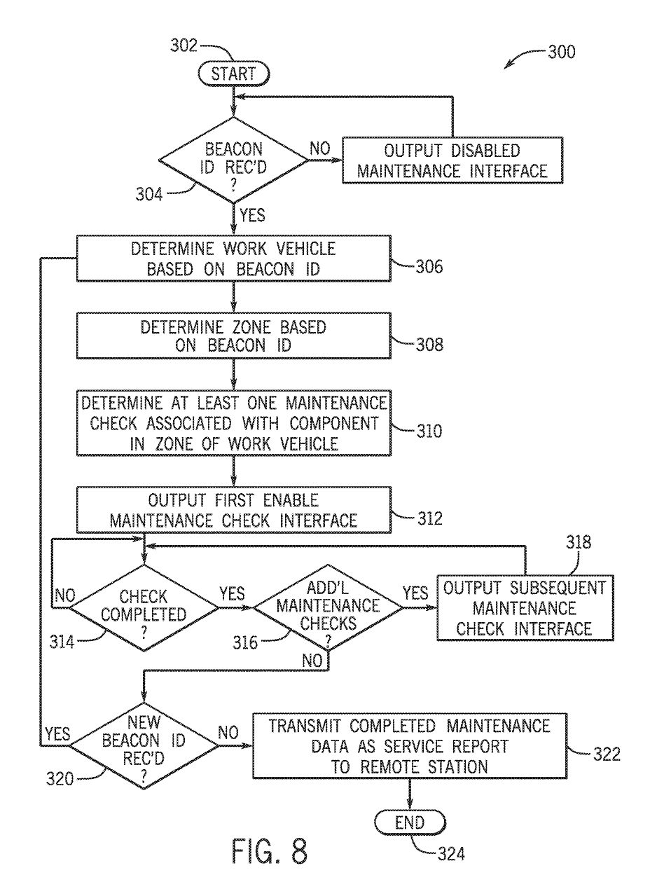

Referring now also to FIG. 8, a flowchart illustrates a control method 300 that may be performed by the device controller 70 of FIGS. 1 and 2 in accordance with the present disclosure. As can be appreciated in light of the disclosure, the order of operation within the method is not limited to the sequential execution as illustrated in FIG. 8, but may be performed in one or more varying orders as applicable and in accordance with the present disclosure.

In various embodiments, the method may be scheduled to run based on predetermined events, and/or can run based on the receipt of input data 218, for example.

In one example, with reference to FIG. 8, the method begins at 302. At 304, the method determines whether the beacon ID data 232 has been received, such that the portable electronic device 62 is in proximity to one of the zone identification beacons 102 and the device communication component 66 has received the zone identification signal 104. Based on the receipt of the beacon ID data 232, the method proceeds to 306. Otherwise, at 308, the method outputs the disable maintenance check user interface 230 for display on the display 74 and continues to determine whether the beacon ID data 232 has been received.

At 306, the method determines the work vehicle 240 based on the beacon ID 234. In one example, the method queries the work vehicle data store 208 based on the beacon ID 234, and retrieves the particular work vehicle 240 identified from the beacon ID 234. At 308, the method determines the zone 244 based on the beacon ID 234. In one example, the method queries the zone data store 212 based on the beacon ID 234 and type of work vehicle identified in the type data 242, and retrieves the particular zone 244.

At 310, the method determines at least one maintenance check associated with a component in the identified zone of the identified work vehicle. In one example, the method queries the component data store 216 based on the work vehicle data 246 to retrieve the component 248 within the identified zone of the identified work vehicle, and queries the maintenance check data store 217 to retrieve the routine maintenance check for the particular component 248.

At 312, the method outputs a first enable maintenance check user interface 228 for display on the display 74. At 314, the method determines whether the maintenance check has been completed, such that the verification 220 has been received via the input device 72. If the verification 220 has been received that indicates the maintenance check has been completed, the method proceeds to 316. The method also sets the service data 236 that indicates that the maintenance check has been completed for the particular component. If no verification 220 has been received, the method loops.

At 316, the method determines whether the identified zone has additional components that require maintenance checks. In one example, upon receipt of the verification 220, the method queries the component data store 216 to determine whether additional components 248 are associated with the identified zone and identified type of work vehicle from the work vehicle data 246. Based on the identification of a subsequent component, at 318, the method outputs a subsequent enable maintenance check user interface 228. In one example, based on the identification of the subsequent component 248, the method queries the maintenance check data store 217 to retrieve the maintenance check 250 associated with the subsequent component 248.

At 320, the method determines whether a new beacon ID 234 has been received, such that the portable electronic device 62 is in proximity to another, different zone identification beacon 102 that is actively transmitting a different zone identification signal 104. Based on the receipt of a new beacon ID 234, the method proceeds to 306.

Otherwise, at 322, the method transmits the completed maintenance data as service report data 238 to the remote system 80. The method ends at 324.

As will be appreciated by one skilled in the art, certain aspects of the disclosed subject matter can be embodied as a method, system (e.g., a work vehicle control system included in a work vehicle), or computer program product. Accordingly, certain embodiments can be implemented entirely as hardware, entirely as software (including firmware, resident software, micro-code, etc.) or as a combination of software and hardware (and other) aspects. Furthermore, certain embodiments can take the form of a computer program product on a computer-usable storage medium having computer-usable program code embodied in the medium.

Any suitable computer usable or computer readable medium can be utilized. The computer usable medium can be a computer readable signal medium or a computer readable storage medium. A computer-usable, or computer-readable, storage medium (including a storage device associated with a computing device or client electronic device) can be, for example, but is not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium can be any tangible medium that can contain, or store a program for use by or in connection with the instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be non-transitory and can be any computer readable medium that is not a computer readable storage medium and that can communicate, propagate, or transport a program for use by or in connection with an instruction execution system, apparatus, or device.

Aspects of certain embodiments are described herein can be described with reference to flowchart illustrations and/or block diagrams of methods, apparatus (systems) and computer program products according to embodiments of the invention. It will be understood that each block of any such flowchart illustrations and/or block diagrams, and combinations of blocks in such flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any flowchart and block diagrams in the figures, or similar discussion above, can illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block (or otherwise described herein) can occur out of the order noted in the figures. For example, two blocks shown in succession (or two operations described in succession) can, in fact, be executed substantially concurrently, or the blocks (or operations) can sometimes be executed in the reverse order, depending upon the functionality involved. It will also be noted that each block of any block diagram and/or flowchart illustration, and combinations of blocks in any block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A service verification system for a work vehicle having a component that requires maintenance checks, the service verification system comprising:
a zone associated with the component, the zone including a source that actively transmits a zone identifier over the zone; and
a controller that receives and processes the zone identifier when the controller is in the zone, and based on the received zone identifier, the controller outputs at least one maintenance check to be completed for the component.

2. The service verification system of claim 1, wherein the source actively transmits a work vehicle identifier, the controller receives and processes the work vehicle identifier when the controller is in the zone and the controller outputs the at least one maintenance check based on the zone identifier and the work vehicle identifier.

3. The service verification system of claim 1, wherein the at least one maintenance check is output for display on a display in communication with the controller.

4. The service verification system of claim 1, further comprising:
an input device that receives input data regarding the completion of the at least one maintenance check,
wherein the controller receives and processes the input data, and the controller outputs a second, subsequent maintenance check based on the received input data.

5. The service verification system of claim 1, further comprising:
an input device that receives input data regarding the completion of the at least one maintenance check,
wherein the controller receives and processes the input data, and based on the received input data, the controller transmits a report that the at least one maintenance check has been completed to a remote station.

6. The service verification system of claim 1, wherein the controller is associated with a portable electronic device.

7. The service verification system of claim 1, wherein the zone is defined by at least one structure of the work vehicle.

8. The service verification system of claim 1, wherein the source that actively transmits the zone identifier is a beacon coupled to the work vehicle that defines the zone and that has a Bluetooth transmitter that actively transmits the zone identifier over a Bluetooth communication protocol.

9. The service verification system of claim 1, wherein the work vehicle comprises a plurality of components that each require maintenance checks, the zone of the service verification system comprises a plurality of zones and the source comprises a plurality of sources, with each zone of the plurality of zones associated with one of the plurality of components and each source of the plurality of sources associated with a single zone of the plurality of zones such that the controller outputs at least one maintenance check to be completed for each of the plurality of components based on the received zone identifier when the at least one controller is in a respective one of the plurality of zones.

10. A service verification method for a work vehicle having a component that requires maintenance checks, the method comprising:
actively transmitting a zone identifier over a zone associated with the component;
receiving, by a controller, the zone identifier when the controller is in the zone;
processing, by the controller, the received zone identifier; and
outputting, by the controller, at least one maintenance check to be completed for the at least one component based on the processing.

11. The method of claim 10, wherein outputting the at least one maintenance check further comprises:
outputting the at least one maintenance check for display on a display in communication with the controller.

12. The method of claim 10, further comprising:
receiving input that indicates the at least one maintenance check has been completed; and
outputting a second, subsequent maintenance check based on the received input.

13. The method of claim 10, further comprising:
receiving input that indicates the at least one maintenance check has been completed; and
transmitting a report that the at least one maintenance check has been completed to a remote station.

14. The method of claim 10, wherein the actively transmitting further comprises:
actively transmitting the zone identifier with a Bluetooth device coupled to the work vehicle that defines the zone.

15. The method of claim 10, further comprising:
actively transmitting a work vehicle identifier over the zone;
receiving and processing the work vehicle identifier by the controller; and
outputting the at least one maintenance check by the controller based on the zone identifier and the work vehicle identifier.

16. A service verification system for a work vehicle having a plurality of components that each require maintenance checks, the service verification system comprising:
a plurality of zones each associated with a respective one of the plurality of components, and each of the plurality of zones including a source that actively transmits a zone identifier over the respective one of the plurality of zones; and
a controller that receives and processes the zone identifier when the controller is in the respective one of the plurality of zones, and based on the received zone identifier, the controller outputs at least one maintenance check to be completed for the component associated with the respective one of the plurality of zones.

17. The service verification system of claim 16, wherein the source actively transmits a work vehicle identifier, the controller receives and processes the work vehicle identifier when the controller is in the respective one of the plurality of zones and the controller outputs the at least one maintenance check based on the zone identifier and the work vehicle identifier.

18. The service verification system of claim 16, wherein the at least one maintenance check is output for display on a display in communication with the controller.

19. The service verification system of claim 16, further comprising:
an input device that receives input data regarding the completion of the at least one maintenance check,
wherein the controller receives and processes the input data, and based on the received input data, the controller transmits a report that the at least one maintenance check has been completed to a remote station.

20. The service verification system of claim 16, wherein the controller is associated with a portable electronic device.
